(19) United States
(12) Patent Application Publication
(10) Pub. No.: US 2011/0131853 A1
(43) Pub. Date: Jun. 9, 2011

(54) Mowable sign post

(76) Inventor: Benton Frederick Baugh, Houston, TX (US)

(21) Appl. No.: 12/592,977

(22) Filed: Dec. 7, 2009

(51) Int. Cl. G09F 15/00

(52) U.S. Cl. 40/608

(57) ABSTRACT

The method of providing non-stop mowing access to a street sign comprising of providing a support for a street sign which moves from a first position in the path of the mower blade to a second position out of the path of the mower blade as the mower blade approaches, and providing that the support for the street sign moves back from the second position to the first position when the mower blade has passed the street sign.

### TECHNICAL FIELD

This invention relates to the general subject of signs and the methods for mowing the vegetation at the base of the sign posts.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The field of this invention is that of signs for along the side of streets, roads, and highways. Typically a mower with a side attachment mows in a continuous path until a sign is encountered. When a sign is encountered, mowing must be stopped and the equipment diverted around the sign.

After requiring the diversion, a second task must be done to remove the grass and/or weeds around the sign. The equipment present may be flexible enough to drive around the sign post, alternate more flexible equipment must be dispatched to do the detail work around the signs, or it is simply left as it is

This has been the pattern for the last century or so when powered mowers become available to do the bulk of the mowing work. The powered mowers have been able to do 99% of the work, but have not been able to fully automate the last 1%—around signs.

### BRIEF SUMMARY OF THE INVENTION

The object of this invention is to provide a sign post which allows a tractor with a side mowing attachment to mow the grass up to and around the sign in a continuous motion.

A second object of this invention is to provide a sign post which automatically deflects as a mowing device approaches.

A third object of this invention is to provide a sign post which automatically returns to the original position after the mowing device has passed

### BRIEF DESCRIPTION OF THE DRAWINGS

FIG. 1 is a perspective view of a sign of the present invention with a mower approaching.

FIG. 2 is a top view of the sign and mower of FIG. 1.

FIG. 3 is a view from the rear of the mower generally taken along lines “3-3” of FIG. 2.

FIG. 4 is a view from the rear of the mower showing the mower approaching the sign.

FIG. 5 is a view of the mower of FIG. 4 having engaged the sign to pivot it up out of the way for the mower to pass.

### DETAILED DESCRIPTION OF THE INVENTION

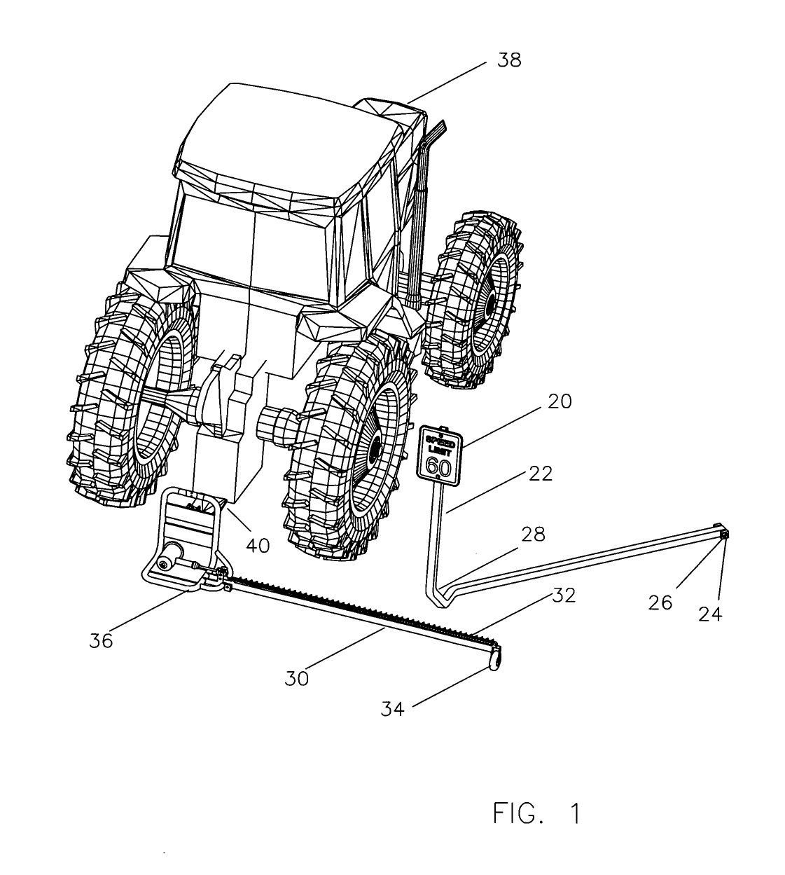

Referring now to FIG. 1, sign 20 is mounted on post 22 which is pivotably mounted by an axle 24 on mountings 26. Post 22 has an inclined section 28 for engagement of mower 30. Mower 30 shows a multiplicity of cutting teeth 32, support wheel 34, and powered mount 36 which engages tractor 38 at mounting 40.

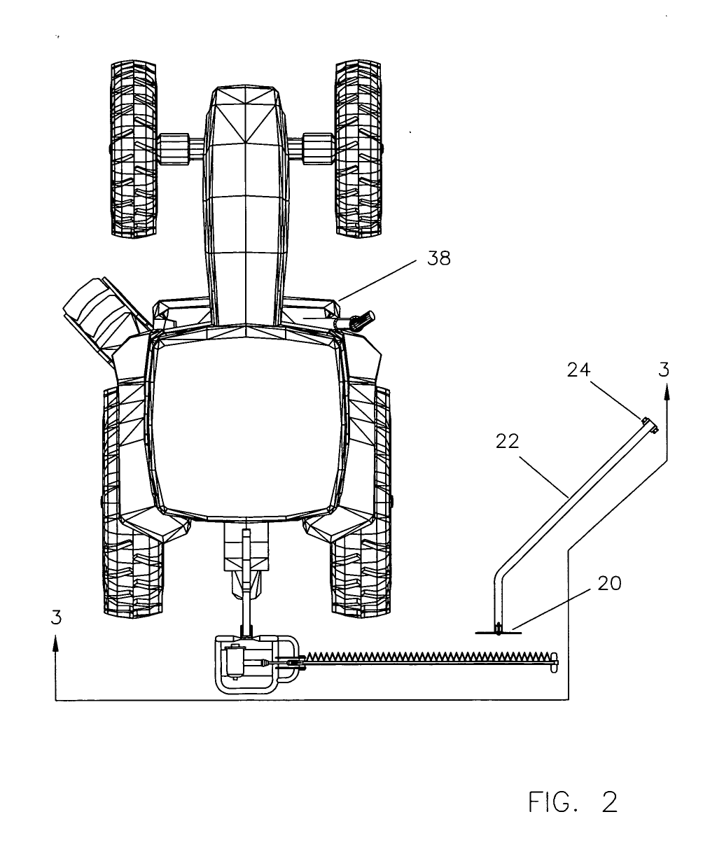

Referring now to FIG. 2, it can be seen that post 22 extends to the rear of sign 20 and away from tractor 38 a considerable distance to promote pivoting about axle 24.

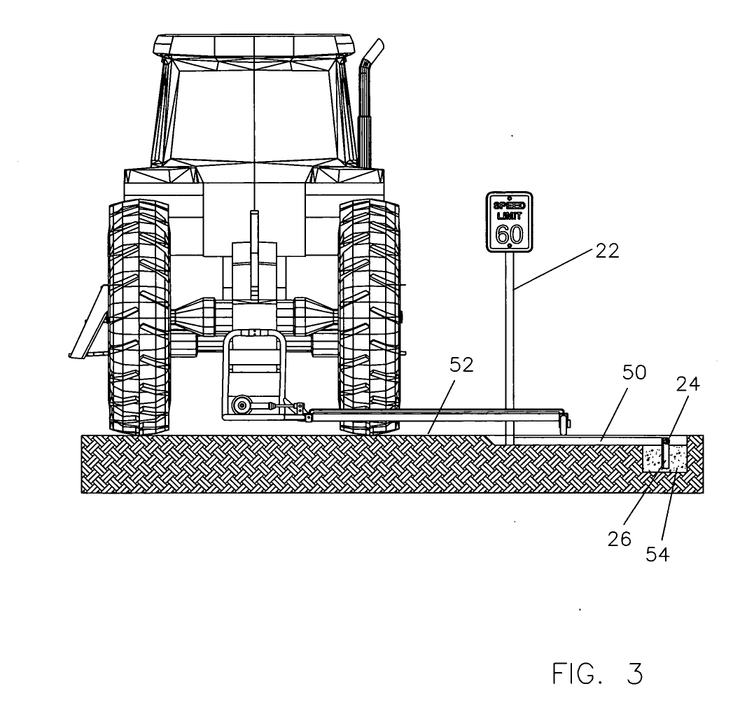

Referring now to FIG. 3, it can be seen that the horizontal portion 50 of post 22 along with pivot 24 and mountings 26 are installed below ground level 52. Mountings 26 are shown as being cast into concrete 54 for a permanent mounting.

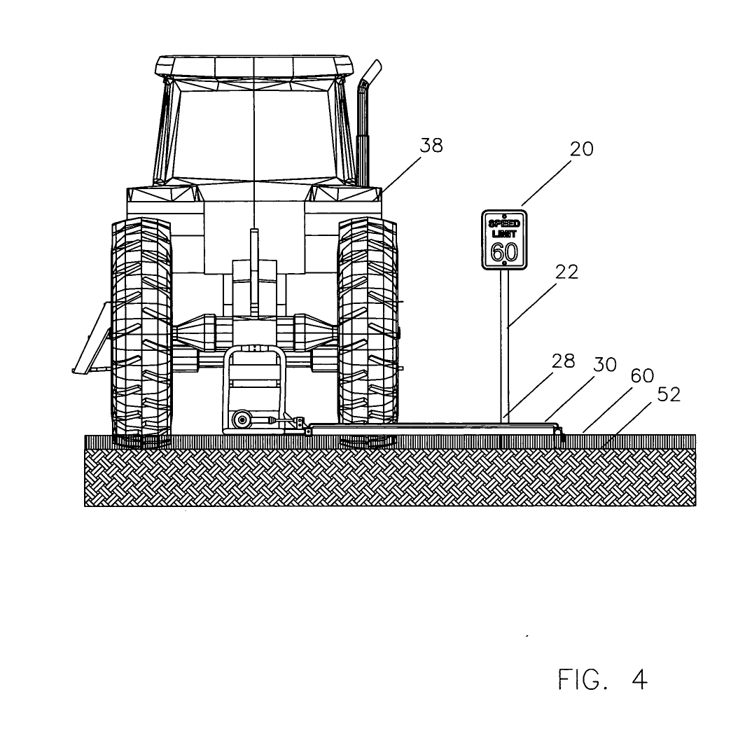

Referring now to FIG. 4, a rear view of the tractor 38 with mower 30 approaching inclined section 28 of post 22 as the grass 60 is being cut.

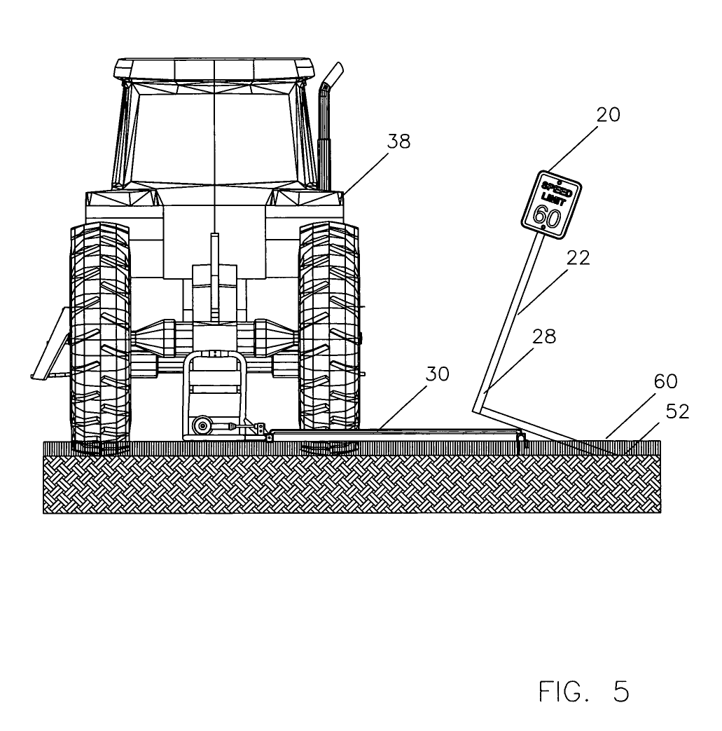

Referring now to FIG. 5, sign 20 along with post 22 is pivoted up and out of the way as mower 30 engages inclined section 28 of the post 22. After the mower 30 passes the horizontal section 50 of the post 22, the post 22 and sign 20 will simply fall back into place due to gravity. The sureness of falling back into place can be assisted by a spring mounted about the axle 24. Alternately, a spring can be put about the axle 24 which will assist in lifting the sign 20 and post 22 as the mower 30 approaches.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of providing non-stop mowing access a street sign, comprising:
providing a support for said street sign which moves from a first position in the path of the mower blade to a second position out of the path of said mower blade as the mower blade approaches, and
providing that said support for said street sign moves back from said second position to said first position when said mower blade has passed said street sign.

2. The method of claim 1 further comprising said street sign and said support return to the first position due to gravity.

3. The method of claim 1 further comprising said street sign and said support return to said first position due to spring force.

4. The method of claim 1 further comprising said street sign and said support are assisted in moving from said first position to said second position by spring force.

5. The method of providing a street sign which can have the grass at the base mowed by a cutter in a continuous swath, comprising:
providing a support post for said street sign in a first position,
providing a pivot mount for said support post which is below the level of said continuous swath of said cutter,
providing a horizontal portion of said support post which is below the level of said continuous swath of said cutter,
providing a portion on said post which engages a portion of said cutter to raise said horizontal portion of said post to pass said cutter, and
allowing said horizontal portion of said post to return to said horizontal position after said cutter passes and has cut said grass.

6. The method of claim 5 further comprising said street sign and said support return to said first position due to gravity.

7. The method of claim 5 further comprising said street sign and said support return to the said first position due to spring force.

8. The method of claim 5 further comprising said street sign and said support are assisted in moving from said first position to said second position by spring force.
